(19) United States
(12) Patent Application Publication
(10) Pub. No.: US 2024/0297341 A1
(43) Pub. Date: Sep. 5, 2024

(54) COMPOSITE INORGANIC ELECTROLYTES FOR SOLID-STATE BATTERIES

(71) Applicant: Uchicago Argonne, LLC, Chicago, IL (US)

(72) Inventors: Jiantao Li, Westmont, IL (US); Jiyu Cai, Willowbrook, IL (US); Zonghai Chen, Bolingbrook, IL (US)

(73) Assignee: Uchicago Argonne, LLC, Chicago, IL (US)

(21) Appl. No.: 18/115,828

(22) Filed: Mar. 1, 2023

(51) Int. Cl. H01M 10/0562

(52) U.S. Cl. CPC H01M 10/0562; H01M 2300/0071; H01M 2300/008; H01M 2300/0091

(57) ABSTRACT

A solid electrolyte includes a first inorganic solid electrolyte and a second inorganic electrolyte. The first inorganic electrolyte has a formula of Li_{3-y}H_{y}OX, where X is at least one halogen and 0<y≤1. The second inorganic solid electrolyte has an ionic conductivity greater than 0.01 mS/cm. The second inorganic solid electrolyte is dispersed in the first inorganic solid electrolyte, forming a composite inorganic solid electrolyte.

### STATEMENT OF GOVERNMENT INTEREST

This invention was made with government support under Contract No. DE-AC02-06CH11357 awarded by the U.S. Department of Energy. The government has certain rights in the invention.

### FIELD

The present invention relates generally to the field of solid-state lithium batteries, and more specifically is related to composite solid-state electrolytes for rechargeable batteries.

### BACKGROUND

Solid-state lithium batteries are a class of electrochemical cells that include an anode, a cathode, and a solid-state electrolyte (SSE) sandwiched between the anode and the cathode. The SSE is an ionic conductive material. When a solid-state lithium battery is charged, lithium ions move from the cathode to the anode via diffusion through the SSE. During discharging, lithium ions move from the anode to the cathode via diffusion through the SSE.

Inorganic SSEs are of interest because of their thermal stability, chemical stability, non-volatility, and non-combustible nature. Because of their favorable properties, inorganic SSEs have potential for use in high-energy-density and safe lithium batteries. Some promising SSEs, like Li_{6.4}La₃Zr_{1.4}Ta_{0.6}O₁₂ (LLZTO) and Li_{1.3}Al_{0.3}Ti_{1.7}(PO₄)₃ (LATP), have exhibited high ionic conductivity and good chemical compatibility with Li metal anodes and Ni-rich cathodes. However, these SSEs are conventionally processed at high temperatures (e.g., 800° C. or higher). These high temperatures are conventionally needed to generate dense and pinhole-free SSE structures with sufficient ionic conductivity, and to create intimate contact between the electrolyte and the cathode electrode material.

However, these high processing temperatures pose a technical barrier to the adoption of SSEs. The high temperature processing can decompose, degrade, electrode active materials, and/or burn conductive agents, creating a challenge for fabricating low resistance electrode/electrolyte interfaces. Furthermore, high-temperature processing tends to increase fabrication costs and may not be cost-effective for scalable processing of SSEs at the industrial level.

### SUMMARY

In one aspect, a composite solid-state electrolyte is provided. The composite electrolyte includes a first inorganic solid electrolyte and a second inorganic solid electrolyte. The first inorganic solid electrolyte has a formula of Li_{3-y}H_{y}OX, where X is at least one halogen and 0<y≤1. The second inorganic solid electrolyte has a higher ionic conductivity than the first inorganic solid electrolyte. The ionic conductivity of the second inorganic solid electrolyte is greater than 0.01 millisiemens per centimeter (mS/cm). The second inorganic solid electrolyte is dispersed in the first inorganic solid electrolyte, forming a composite inorganic solid electrolyte. In some embodiments, the first inorganic solid electrolyte and the second inorganic solid electrolyte are compounded together to form a composite inorganic solid electrolyte.

In some embodiments, the first inorganic solid electrolyte has an anti-perovskite crystal structure and a melting temperature less than 500° C. In some embodiments, X may be F, Cl, Br, I, or a mixture of any two or more thereof. The first inorganic solid electrolyte may include at least one of Li₂OHCl, Li₂OHCl_{0.25}Br_{0.75}, Li₂OHCl_{0.75}Br_{0.25}, Li₂OHBr, and Li₂OHCl_{0.5}Br_{0.5}.

The second inorganic solid electrolyte may include at least one of a garnet-type solid electrolyte and a LiSICON solid electrolyte. The garnet-type solid electrolyte may include at least one of lithium lanthanum zirconium oxide (Li₇La₃Zr₂O₁₂), lithium lanthanum zirconium tantalum oxide (Li₇₋ₓLa₃Zr₂₋ₓTaₓO₁₂, wherein 0<x<2), lithium lanthanum titanium oxide (LiₓLa_{(2-x)/3}TiO₃, 0<x<2), and lithium lanthanum bismuth oxide (Li₅La₃Bi₂O₁₂). The lithium lanthanum zirconium tantalum oxide (Li₇₋ₓLa₃Zr₂₋ₓTaₓO₁₂, wherein 0<x<2) may have a formula of Li_{6.4}La₃Zr_{1.4}Ta_{0.6}O₁₂. The LiSICON solid electrolyte may include lithium aluminum titanium phosphate (Li₁₊ₓAlₓTi₂₋ₓ(PO₄)₃, 0<x<2). The lithium aluminum titanium phosphate (Li₁₊ₓAlₓTi₂₋ₓ(PO₄)₃, 0<x<2) may have a formula of Li_{1.3}Al_{0.3}Ti_{1.7}(PO₄)₃.

In some embodiments, the first inorganic solid electrolyte and the second inorganic solid electrolyte are present in the composite electrolyte in a ratio of about 1:9 to about 9:1.

In another aspect, a solid-state battery is provided. The solid state battery includes a cathode, an anode, and a composite inorganic electrolyte disposed between and in physical contact with the cathode and the anode. The composite inorganic electrolyte includes a dispersion of a second inorganic solid electrolyte in a first inorganic solid electrolyte. The first inorganic solid electrolyte has a formula of Li_{3-y}H_{y}OX where X is at least one halogen and 0<y≤1. At least a portion of the composite inorganic electrolyte is contained in at least one of the cathode or the anode.

In some embodiments, the anode includes at least one of metallic lithium, graphite, and Si. In some embodiments, the cathode includes LiFe₁₋ₓMnₓPO₄, Li₁₊ₓMn₂₋ₓO₄, LiNiₓMn_{y}Co_{1-x-y}O₂, or a mixture of two or more thereof, with the variables 0≤x≤1, 0≤y≤1, and 0≤x+y≤1. The cathode may further include a doping element selected from a group including Mg, Ca, Zr, Ti, Ta, V, Cr, Fe, Zn, Al, and any combination of two or more thereof.

### BRIEF DESCRIPTION OF THE DRAWINGS

FIG. 1 is a schematic representation of an embodiment of the formation of a composite solid electrolyte.

FIG. 2 is a flow chart of an embodiment of the process for forming a composite solid electrolyte.

FIG. 3 is another schematic representation of an embodiment of the formation of an all-solid-state battery with a composite electrolyte.

FIG. 4 shows in situ X-ray diffraction (XRD) patterns showing the evolution of reactants and products during the synthesis of Li₂HOCl.

FIGS. 5A-5E are thermal analysis graphs of protonated anti-perovskite solid electrolytes.

FIG. 6 is an XRD graph of solid electrolytes Li₂HOCl_{0.75}Br_{0.25}, Li_{6.4}La₃Zr_{1.4}Ta_{0.6}O₁₂, and a composite of Li₂HOCl_{0.75}Br_{0.25} and Li_{6.4}La₃Zr_{1.4}Ta_{0.6}O₁₂ after low-temperature processing.

FIG. 7 is an Arrhenius conductivity graph of Li₂HOCl_{0.75}Br_{0.25}/LLZTO composite solid electrolytes with different volume ratios.

FIG. 8 is a graph of the activation energy and ionic conductivity of Li₂HOCl_{0.75}Br_{0.25}/LLZTO composite solid electrolytes with different volume ratios.

FIG. 9 is an Arrhenius conductivity graph of Li₂HOCl_{0.75}Br_{0.25}/LATP composite solid electrolytes with different volume ratios.

FIG. 10 is a graph of the activation energy and ionic conductivity of Li₂HOCl_{0.75}Br_{0.25}/LATP composite solid electrolytes with different volume ratios.

FIG. 11 is a graph of the electrochemical cycling performance of a symmetrical Li metal electrochemical cell with a Li₂HOCl_{0.75}Br_{0.25}/LLZTO composite solid electrolyte.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Disclosed herein are solid-state inorganic composite electrolytes for solid-state electrochemical cells and processes for fabricating these composite electrolytes. The solid-state inorganic composite electrolytes are fabricated using low-temperature processing, lending several advantages. One advantage is the ability to generate composite electrodes that include composite electrolyte to increase ionic conductivity through the electrode without heating the composite electrode at temperatures that can degrade electrode active materials and/or conductive additives in the electrode. Another advantage is the ability to generate low-resistance interfaces between the electrolyte and the electrodes without heating the electrolyte and electrode at temperatures that can degrade electrode active materials and conductive additives. Another advantage is the cost-savings associated with operating at a lower temperature.

The composite electrolyte includes two or more solid-state inorganic electrolytes (SSEs) with different melting temperatures. The composite electrolyte may include a SSE “A” having a lower melting temperature and a SSE “B” having a higher melting temperature. The SSE B may have a higher ionic conductivity than SSE A. The different SSE components in the composite electrolyte may be mixed together and evenly dispersed throughout the composite electrolyte.

In some embodiments, the SSE B is dispersed in the SSE A. In other words, the SSE A may act as a medium in which particles of the SSE B are distributed. In some cases, the particles of SSE B are distributed substantially uniformly in the SSE A. The SSE A and the SSE B may be compounded together to form the composite inorganic solid electrolyte.

The composite electrolyte may be fabricated without heating the electrolyte materials at high temperatures (e.g., 800° C. or higher) that are conventionally used to generate dense, pinhole-free, and mechanically stable SSE structures with sufficient ionic conductivity. Instead, the composite electrolyte benefits from the low melting point of the SSE A. The composite electrolyte is fabricated by heating a mixture of the electrolyte components SSE A and SSE B at much lower temperatures (e.g., less than 500° C.) than is conventionally used to process SSE. The resulting composite electrolyte is a dense, pinhole-free, mechanically stable electrolyte exhibiting sufficient ionic conductivity for stable electrochemical cycling. The processing temperature used to generate the composite electrolyte can be lower than conventionally used because of the lower melting temperature of the SSE A. Heating the mixture of electrolyte components at or above the melting temperature of the SSE A, but below the melting temperature of the SSE B, may allow the SSE A in its liquid state to fill pores and pin-holes between particles of SSE B, thereby creating a dense and pinhole-free or substantially pinhole-free composite electrolyte.

The difference in melting temperature between the SSE A and the SSE B may be a difference of about 100° C. ° C. to about 1000° C. ° C. For example, the difference in temperature may be about 100° C. ° C., about 200° C. ° C., about 300° C. ° C., about 400° C. ° C., about 500° C. ° C., about 600° C. ° C., about 700° C. ° C., about 800° C. ° C., about 900° C. ° C., or about 1000° C. ° C. In some embodiments, the temperature difference is preferably at least about 700° C. ° C.

In some embodiments, the melting temperature of the SSE A may be less than 600° C. In some embodiments, the melting temperature of the SSE A may be less than 500° C. In some embodiments, the melting temperature of the SSE A may be about 50° C. to about 600° C. For example, the melting temperature of the SSE A may be about 50° C., about 100° C., about 150° C., about 200° C., about 250° C., about 300° C., about 400° C., about 500° C., about 600. In some cases, the melting temperature of the SSE A is preferably about 100° C. to about 500° C. In some cases, the melting temperature of the SSE A is preferably about 100° C. to about 300° C.

The SSE B may have a higher ionic conductivity than the SSE A. In some embodiments, the SSE B may have an ionic conductivity at a temperature of about 20° C. to about 90° C. of about 1×10⁻⁴ S/cm to about 10 S/cm. For example, the SSE B may have an ionic conductivity of at least about 1×10⁻⁴ S/cm, about 1×10⁻³ S/cm, about 1×10⁻² S/cm, about 0.1 S/cm, or about 1 S/cm. In some embodiments, the ionic conductivity of SSE B is preferably at least about 1×10⁻³ S/cm at 90° C.

The composite electrolyte has an ionic conductivity sufficient for stable electrochemical cycling. In some embodiments, the composite electrolyte has an ionic conductivity at a temperature of about 20° C. to about 90° C. of about 1×10⁻⁵ S/cm to about 10 S/cm. For example, the composite electrolyte may have an ionic conductivity of at least about 1×10⁻⁴ S/cm, about 1×10⁻³ S/cm, about 1×10⁻² S/cm, about 0.1 S/cm, or about 1 S/cm. In some embodiments, the ionic conductivity of the composite electrolyte is preferably at least about 5×10⁻⁴ S/cm at 90° C.

The volume ratio of SSE A to SSE B present in the composite SSE may vary from about 10:0 to about 0:10. In some embodiments, the volume ratio of SSE A to SSE B may be about 8:2 to about 2:8. In some embodiments, the volume ratio of SSE A to SSE B may be about 7:3 to about 3:7. In some embodiments, the volume ratio of SSE A to SSE B is preferably about 6:4 to about 3:7. In some embodiments, the volume ratio of SSE A to SSE B is preferably about 3:7 to about 5:5. For example, the volume ratio may be 9:1, 8:2, 7:3, 6:4, 5:5, 4:6, 3:7, 2:8, or 1:9.

In some embodiments, the SSE A may have an anti-perovskite crystal structure. The SSE A may be a protonated anti-perovskite. The SSE A may have a formula of Li_{3-y}H_{y}OX, where X is at least one halogen and 0<y≤1. For example, X may be F, Cl, Br, I, or a mixture of any two or more thereof. For example, the SSE A may include Li₂OHCl, Li₂OHCl_{0.25}Br_{0.75}, Li₂OHCl_{0.75}Br_{0.25}, Li₂OHBr, and/or Li₂OHCl_{0.5}Br_{0.5}. In some embodiments, the SSE A may include one or more precursors used to make Li_{3-y}H_{y}OX, including LiOH and LiX, where X is at least one halogen. In some embodiments, the SSE A includes more than one SSE. The SSE A may include a mixture of one to ten different components. For example, each component in the SSE A may be a protonated anti-perovskite or a precursor thereof.

In some embodiments, the SSE B may be a garnet-type SSE or a LiSICON SSE. The garnet-type SSE may include lithium lanthanum zirconium oxide (Li₇La₃Zr₂O₁₂), lithium lanthanum zirconium tantalum oxide (Li₇₋ₓLa₃Zr₂₋ₓTaₓO₁₂, wherein 0<x<2), lithium lanthanum titanium oxide (LiₓLa_{(2-x)/3}TiO₃, 0<x<2), and/or lithium lanthanum bismuth oxide (Li₅La₃Bi₂O₁₂). For example, the lithium lanthanum zirconium tantalum oxide (Li₇₋ₓLa₃Zr₂₋ₓTaₓO₁₂, wherein 0<x<2) may have a formula of Li_{6.4}La₃Zr_{1.4}Ta_{0.6}O₁₂. The LISICON SSE may include lithium aluminum titanium phosphate (Li₁₊ₓAlₓAlₓTi₂₋ₓ(PO₄)₃, 0<x<2). For example, the lithium aluminum titanium phosphate (Li₁₊ₓAlₓTi₂₋ₓ(PO₄)₃, 0<x<2) may have a formula of Li_{1.3}Al_{0.3}Ti_{1.7}(PO₄)₃. In some embodiments, the SSE B may include a mixture of one to ten different components. For example, each component in the SSE B may be a different garnet-type SSE or LiSICON SSE

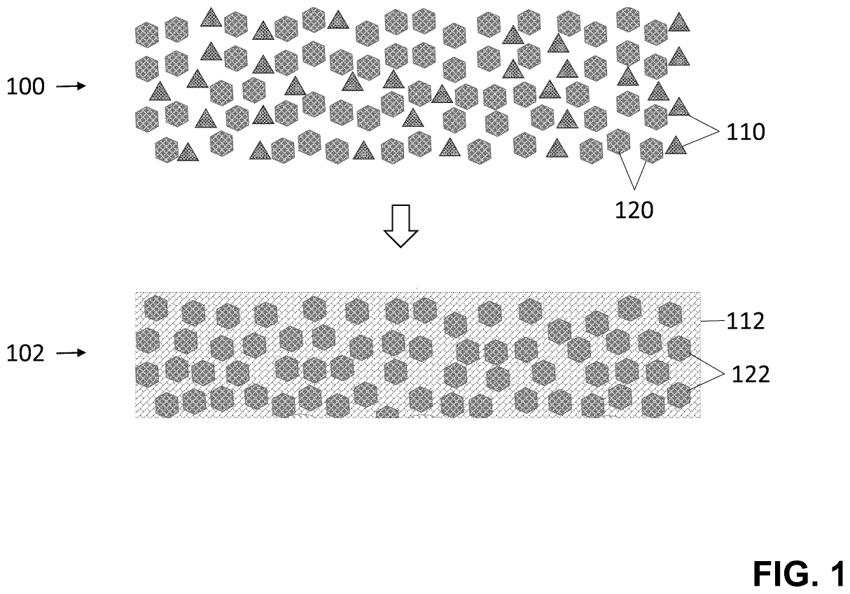

FIG. 1 is a schematic representation of the formation of a composite solid electrolyte. To form the composite solid electrolyte, powders or particles of the SSE A 110 and powders or particles of the SSE B 120 are mixed together to form a mixture 100 of the component parts of the composite solid electrolyte. Once formed, the mixture 100 is heated at a temperature high enough to melt the SSE A 110 but not high enough to melt the SSE B 120. Heating causes the SSE A 110 to melt, filling pores in the matrix and more uniform grain boundaries. Once cooled, the SSE A 112 acts as a medium in which the SSE B 122 is dispersed, thereby forming a dense and pinhole-free solid electrolyte with a sufficient ionic conductivity.

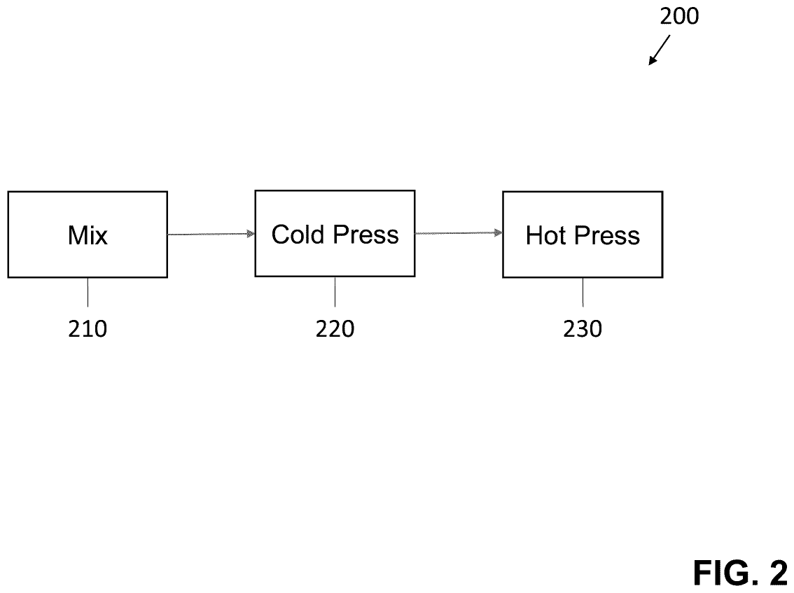

FIG. 2 is a flow chart of an embodiment of the process 200 for forming a composite solid electrolyte. In step 210, powders of SSE A and SSE B are mixed to form a substantially uniform mixture or suspension. In step 220, the mixture/suspension is cold pressed at a temperature of about 15° C. to about 30° C. (e.g., 25° C.) and a pressure of about 100 megapascals (MPa) to about 500 MPa (e.g., 250 MPa) to form a pellet. The pellet is then hot pressed in step 230 at a temperature less than 600° C. (e.g., about 200° C. to about 250° C.) at a pressure of about 10 kilopascals (kPa) to about 50 kPa (e.g., 35 kPa) to form the composite electrolyte. The pellet is hot pressed for about 0.5 hours to about 24 hours. In some embodiments, the pellet is heated in step 230 at a temperature less than 600° C. (e.g., about 200° C. to about 250° C.) with an absence of mechanical pressure to form the composite electrolyte. The pellet is heated for about 0.5 hours to about 24 hours.

In some embodiments, instead of (or in addition to) using a powder of SSE A in step 210 to form the mixture, powders of the precursors used to form SSE A, lithium hydroxide (LiOH) and LiX, where X is at least one halogen are used to form the mixture, are included in the mixture. During the step 230, the LiOH and LiX may react in situ to form the SSE A having a protonated antiperovskite crystal structure and a formula of Li_{3-y}H_{y}OX.

Also disclosed are solid-state electrochemical cells with the composite electrolytes described above and processes for creating these electrochemical cells. Also disclosed are composite electrodes that include these composite electrolytes and processes for creating these composite electrodes.

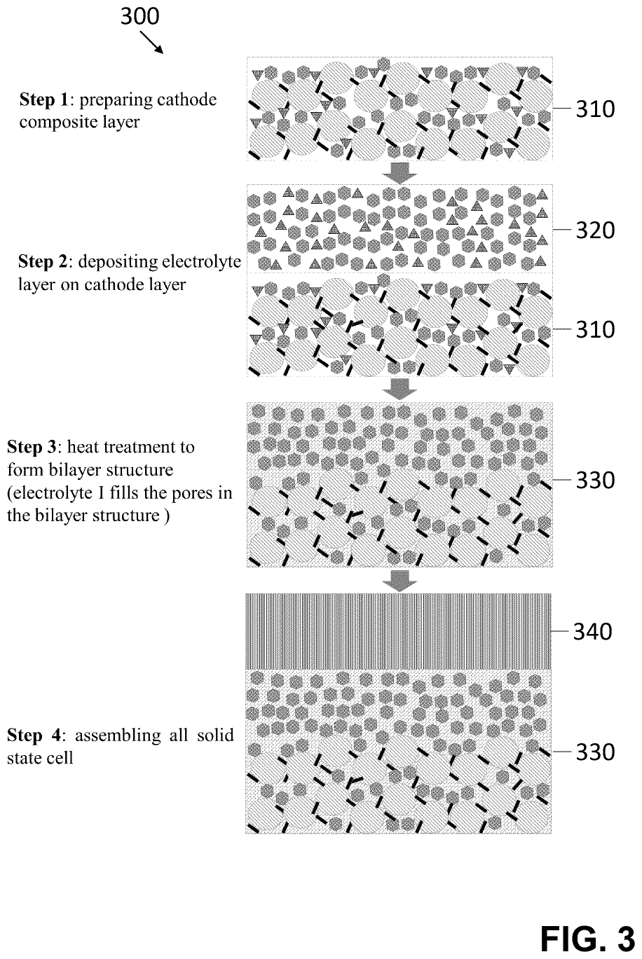

FIG. 3 is a schematic representation of an embodiment of the formation of an all-solid-state battery with a composite electrolyte fabricated with low temperature processing (e.g., less than 600° C.). In step 1, a mixture 310 is prepared containing the components of the composite cathode, including one or more cathode active materials, SSE A, and SSE B. The cathode active materials, SSE A, and SSE B may be in the form of powders or particulates. The mixture 310 may also include conductive additives and/or binders, described in more detail below. The mixture 310 may be cold-pressed to form a pellet. Separately, a mixture 320 of SSE A and SSE B is prepared to form the composite SSE. The mixture 320 may be cold-pressed to form a pellet. In step 2, the cathode mixture 310 and the composite SSE mixture 320 are brought together to form a layer structure. In step 330, the layer structure of the two mixtures 310 and 320 are heat treated at a temperature high enough to melt the SSE A but not high enough to melt the SSE B (e.g., less than 600° C.), thereby forming a mechanically stable bilayer structure 330 mad of the composite cathode and the composite SSE. In step 4, the anode is placed on the composite SSE side of the bilayer structure 330 to form the all-solid-state lithium battery.

In other embodiments, the anode may be prepared using a similar scheme to that shown in FIG. 3. In step 1, a mixture 310 is prepared containing the components of the composite anode, including one or more anode active materials, SSE A, and SSE B. The anode active materials, SSE A, and SSE B may be in the form of powders or particulates. The mixture 310 may also include conductive additives and/or binders, described in more detail below. The mixture 310 may be cold-pressed to form a pellet. Separately, a mixture 320 of SSE A and SSE B is prepared to form the composite SSE. The mixture 320 may be cold-pressed to form a pellet. In step 2, the anode mixture 310 and the composite SSE mixture 320 are brought together to form a layer structure. In step 330, the layer structure of the two mixtures 310 and 320 are heat treated at a temperature high enough to melt the SSE A but not high enough to melt the SSE B (e.g., less than 600° C.), thereby forming a mechanically stable bilayer structure 330 mad of the composite anode and the composite SSE. In some embodiments, the electrochemical cell includes a composite anode and a composite cathode, each electrode including some amount of the composite electrolyte.

Illustrative cathode active materials may include, but are not limited to, a spinel, a olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}CO_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ′}O_{2-z}F_{z″}, or VO₂. In the cathode active materials, M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; B¹ is Ti, V, Cr, Fe, or Zr; 0≤x≤0.3; 0≤y≤0.5; 0≤z≤0.5; 0≤x″≤0.4; 0≤α≤1; 0≤β≤1; 0≤γ≤1; 0≤δ′≤0.4; and 0≤z″≤0.4; with the proviso that at least one of α, β and γ is greater than 0. In some embodiments, the cathode includes LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCoPO₄F, Li₂MnO₃, Li₅FeO₄, and Li_{x′}(Met)O₂, wherein Met is a transition metal and 1<x′≤2. In some embodiments, Met is Ni, Co, Mn, or a mixture of any two or more thereof. In some embodiments, Met is a mixture of Ni, Co, and Mn. In some embodiments, the cathode active material may include LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCoPO₄F, Li₂MnO₃, Li₅FeO₄, or Li_{x′}(Met)O₂, where Met is a transition metal and 1<x′≤2. Other materials may include metallic or semiconducting particles, or plasmonic particles that generate nascent electric fields when irradiated by white light. In some embodiments, the cathode may include a cathode active material that includes manganese. In such embodiments, the cathode active material may include, but is not limited to LiMn_{0.5}Ni_{0.5}O₂, LiMn_{1/3}Co_{1/3}Ni_{1/3}O₂, LiMn₂O₄, LiM⁴_{0.5}Mn_{1.5}O₄, Li_{1+x″}Ni_{α}Mn_{β}Co_{γ}M⁵_{δ′}O_{2-z″}F_{z″}, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiMnPO₄, or Li₂MnO₃, where M⁴ is Al, Mg, Ti, B, Ga, Si, Mn, or Co; M⁵ is Mg, Zn, Al, Ga, B, Zr, or Ti; 0≤x″≤0.4; 0≤α≤1; 0<β≤1; 0≤γ≤1; 0≤δ′≤0.4; 0≤z″≤0.4; and 0≤n′≤3. Example cathode materials include, but are not limited to, LiFePO₄, LiFeₓMn₁₋ₓPO₄ (0≤x≤1), and LiNiₓMn_{y}Co_{1-x-y}O₂ (NMC, 0≤x≤1, 0≤y≤1, 0≤x+y≤1).

Illustrative anode materials include metallic anode active materials such as lithium, sodium, or magnesium; sulfur materials; metal oxides such as TiO₂ or Li₄Ti₅O₁₂; or carbon materials including, but not limited to, synthetic graphite, natural graphite, amorphous carbon, hard carbon, soft carbon, mesocarbon microbeads (MCMB). In any of the above embodiments, the anode may include a graphite material, alloys, intermetallics, silicon, silicon oxides, TiO₂ and Li₄Ti₅O₁₂, and composites thereof. For example, the anode active material may include a metallic anode material intercalated within a host material, where the metallic anode material includes, but is not limited to, lithium, sodium, or magnesium, and the host material may be an active carbon material including, but not limited to, synthetic graphite, natural graphite, amorphous carbon, hard carbon, soft carbon, mesocarbon microbeads (MCMB). In other embodiments, the metallic anode material includes, but is not limited to, lithium, sodium, or magnesium, and metallic anode material is dispersed in a host material, which may be an alloy, intermetallic, silicon, silicon oxide, TiO₂, Li₄Ti₅O₁₂, or mixtures of any two or more thereof. In some embodiments, the anode active material is a lithiated carbon material such as lithiated graphite. Example anode materials for the lithium battery include, but are not limited to, Li metal, meso-carbon microbeads, natural graphite, synthetic graphite, soft carbon, hard carbon, and Si-based alloys.

The composite electrolyte, cathodes, and/or anodes of the lithium batteries may also include one or more conductive additive. In some embodiments, the conductive additive may be a conductive carbon. Examples of conductive carbons include synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, and/or graphene.

The lithium batteries may also include current collectors. Current collectors for the anode and/or the cathode may include those of copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys.

The anodes and cathodes may include one or more binder that holds the electrode active material and other materials in the electrode to the current collector. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatin, a copolymer of any two or more such polymers, or a blend of any two or more such polymers.

The present invention, thus generally described, will be understood more readily by reference to the following examples, which are provided by way of illustration and are not intended to be limiting of the present invention.

### Examples

### Reagents and General Methods

Reagents LiOH·H₂O, LiF, LiCl, LiBr, LiI, Li_{6.4}La₃Zr_{1.4}Ta_{0.6}O₁₂ (LLZTO) and Li_{1.3}Al_{0.3}Ti_{1.7}(PO₄)₃ (LATP) were used as received from commercial suppliers. Li_{3-α}H_{α}OX, where X is F, Cl, Br, I or a mixture of two or more of hereof, and 0<α<1, was synthesized by mixing LiOH·H₂O and LiX in a stoichiometric ratio, and then heating at 250° C. to 500° C. for 12 hours. Li_{3-y}H_{y}OX powder was obtained after ball-milling under inert atmosphere.

The Li_{3-α}H_{α}OX-based composite inorganic SSE pellets were prepared as follows: a series of homogeneous powder mixtures with different volume ratios of Li_{3-α}H_{α}OX and highly conductive inorganic SSEs were cold-pressed into pellets under 100 MPa to 250 MPa, and then hot-pressed at 200° C. to 250° C. under 35 kPa for 0.5 h. In some aspect, the composite electrolyte pellets are treated at a temperature of 200° C. to 400° C. for an extended period between 1 hour and 24 hours to form mechanically stable pellets.

For the conductivity measurements of composite inorganic SSEs, the as-prepared pellets were sandwiched between two stainless-steel electrodes in Swagelok cells, and then electrochemical impedance spectroscopy (EIS) tests were carried out at different temperature (25° C., 45° C., 60° C., 75° C., and 90° C.) in the frequency range of 1 MHz to 1 Hz with a 10 mV driving potential amplitude. The electrochemical cycling performance of composite electrolyte was also tested in Swagelok-type symmetrical cells with lithium metal as electrodes. The charge/discharge current density was set at 0.1 mA/cm², 0.2 mA/cm², 0.5 mA/cm², and 1.0 mA/cm².

This invention will be further illustrated below in the following non-limiting examples.

### Preparation and Analysis of Protonated Anti-Perovskite Electrolytes

Li₂HOCl was prepared as follows. 10.0 g of LiOH·H₂O and 10.10 g of LiCl were homogeneously mixed in a Polytetrafluoroethylene (PTFE)-based container, and then heated at 320° C. for 12 hours in a muffle furnace. After cooling to room temperature, the mixture was ball-milled under inert atmosphere and Li₂HOCl powder was obtained.

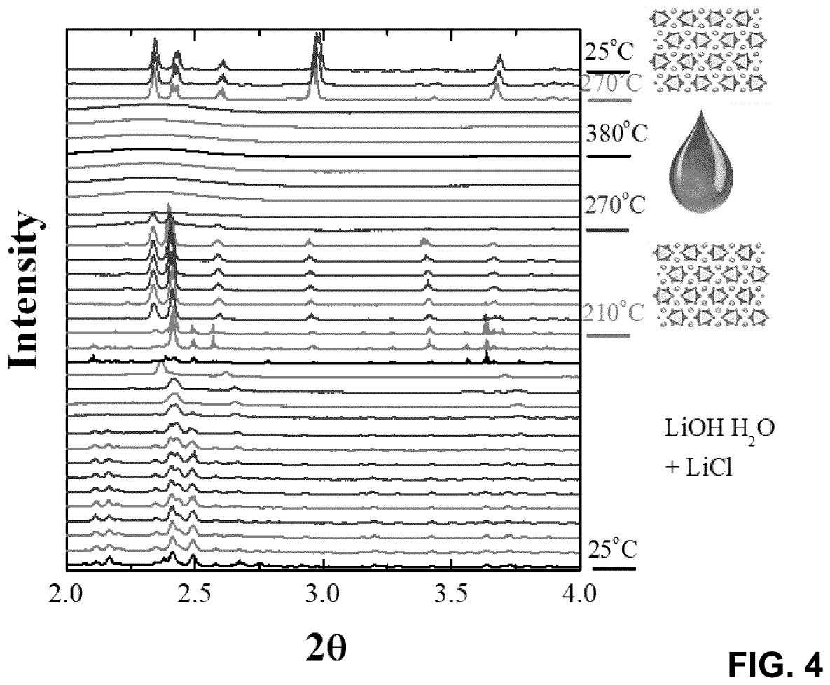

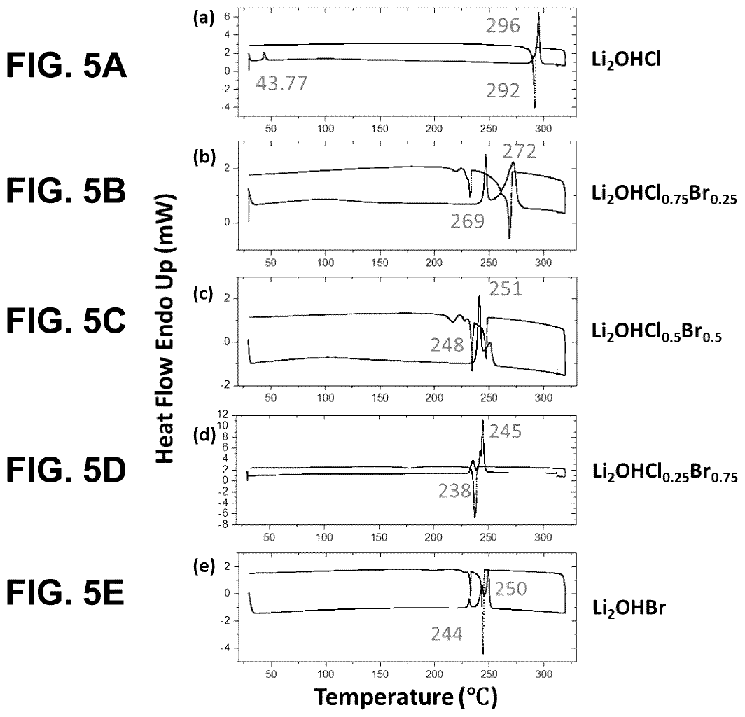

FIG. 4 shows the in-situ X-ray diffraction (XRD) study of the formation of Li₂HOCl. As shown in FIG. 4, Li₂HOCl crystals formed at a temperature higher than 210° C. and began to melt at a temperature higher than 270° C., and liquid Li₂HOCl completely formed when the temperature rose to 270-380° C. Li₂HOCl crystals formed again when the temperature dropped to room temperature. Thermogravimetric analysis (TGA) in FIG. 5A also showed that Li₂HOCl has a melting point at around 290° C.

Li₂HOCl_{0.75}Br_{0.25} was prepared as follows. 10.0 g of LiOH·H₂O, 7.58 g of LiCl and 5.17 g of LiBr were homogeneously mixed in a PTFE-based container, and then heated at 320° C. for 12 hours in a muffle furnace. After cooling to room temperature, the sample was ball-milled under inert atmosphere and Li₂HOCl_{0.75}Br_{0.25} powder was obtained. TGA shown in FIG. 5B was used to determine that Li₂HOCl has a melting point at around 270° C.

Li₂HOCl_{0.5}Br_{0.5} was prepared as follows. 10.0 g of LiOH·H₂O, 5.05 g of LiCl and 10.35 g of LiBr were homogeneously mixed in a PTFE-based container, and then heated at 320° C. for 12 hours in a muffle furnace. After cooling to room temperature, the sample was ball-milled under inert atmosphere and Li₂HOCl_{0.5}Br_{0.5} powder was obtained. TGA shown in FIG. 5C was used to determine that Li₂HOCl has a melting point at around 250° C.

Li₂HOCl_{0.25}Br_{0.75} was prepared as follows. 10.0 g of LiOH·H₂O, 2.53 g of LiCi and 15.52 g of LiBr were homogeneously mixed in a PTFE-based container, and then heated at 320° C. for 12 hours in a muffle furnace. After cooling to room temperature, the sample was ball-milled under inert atmosphere and Li₂HOCl_{0.25}Br_{0.75} powder was obtained. TGA shown in FIG. 5D was used to determine that Li₂HOCl has a melting point at around 245° C.

Li₂HOBr was prepared as follows. 10.0 g of LiOH·H₂O and 20.70 g of LiBr were homogeneously mixed in a PTFE-based container, and then heated at 320° C. for 12 hours in a muffle furnace. After cooling to room temperature, the sample was ball-milled under inert atmosphere and Li₂HOBr powder was obtained. TGA shown in FIG. 5C was used to determine that Li₂HOCl has a melting point at around 245° C.

### Preparation and Analysis of Composite Inorganic Solid-State Electrolyte Based on Li₂HOCl_{0.75}Br_{0.25} and Li_{6.4}La₃Zr_{1.4}Ta_{0.6}O₁₂ (LLZTO)

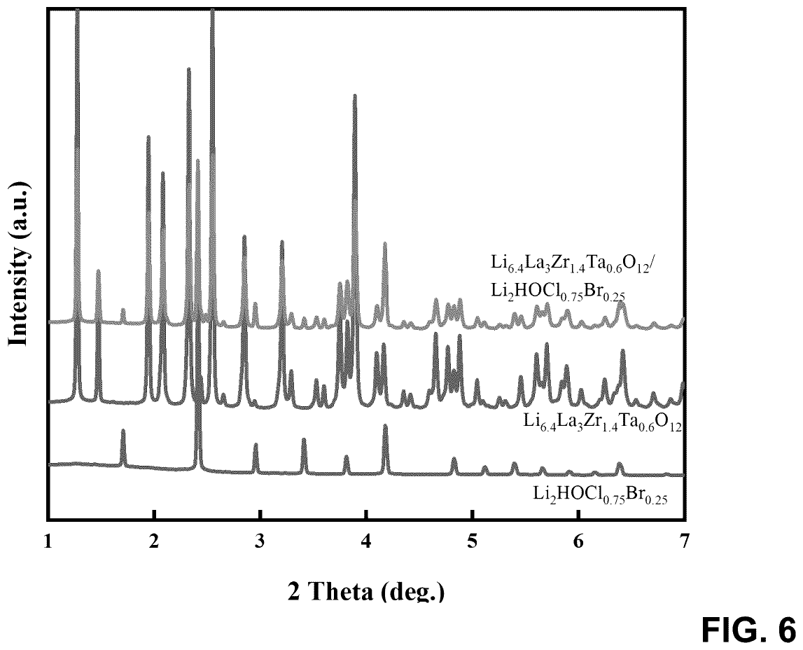

To confirm the crystal structural evolution after mixing protonated anti-perovskite (AP) and other highly conductive inorganic SSEs at the melting point of AP, Li₂HOCl_{0.75}Br_{0.25} and Li_{6.4}La₃Zr_{1.4}Ta_{0.6}O₁₂ were selected and mixed at a temperature higher than 300° C. FIG. 6 shows XRD results indicating that mixing Li₂HOCl_{0.75}Br_{0.25} and Li_{6.4}La₃Zr_{1.4}Ta_{0.6}O₁₂ and heating the mixture at temperatures higher than 300° C. does not induce changes in crystal structural. This finding indicates that the crystal structure of respective components of the composite electrolyte may not change when the composite electrolyte is formed.

To prepare the composite inorganic SSE based on Li₂HOCl_{0.75}Br_{0.25} and LLZTO, a series of Li₂HOCl_{0.75}Br_{0.25} and LLZTO with volume ratios of 10/0, 8/2, 7/3, 6/4, 4/6 and 3/7 were mixed homogeneously. 200 mg of each mixture was cold-pressed into a Φ½ inch pellet under 250 MPa, and then hot-pressed at 250° C. under 35 kPa for 0.5 h. Once cooled, each pellet was dense and mechanically stable.

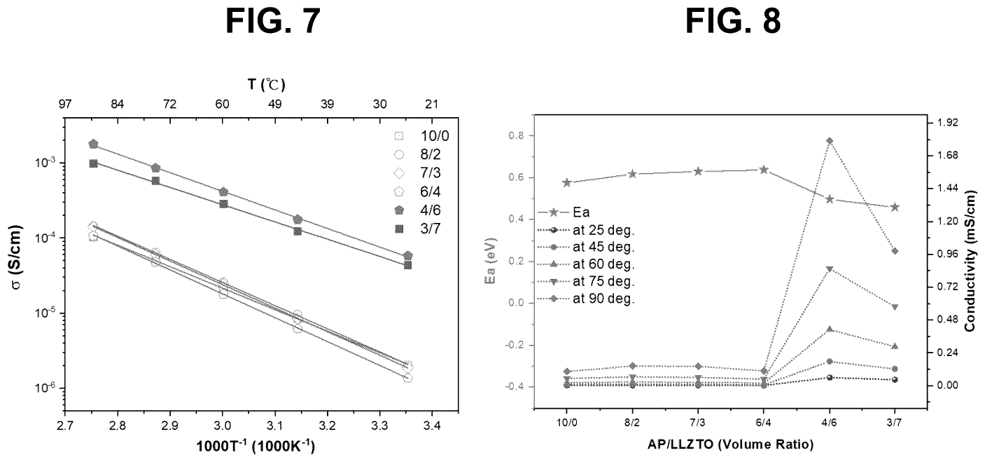

The ionic conductivity of the as-prepared Li₂HOCl_{0.75}Br_{0.25}/LLZTO-based electrolyte was evaluated by EIS tests at temperatures of 25, 45, 60, 75, and 90° C. FIG. 7 shows an Arrhenius conductivity plot based on EIS results. FIG. 8 shows the activation energy and the conductivity for the composite electrolyte Li₂HOCl_{0.75}Br_{0.25}/LLZTO with different volume ratios. FIGS. 7 and 8 indicate that the composite electrolyte Li₂HOCl_{0.75}Br_{0.25}/LLZTO with the volume ratio of 4/6 has a relatively low activation energy and a high ionic conductivity of about 1.79 mS/cm at 90° C.

### Preparation and Analysis of Composite Inorganic Solid-State Electrolyte Based on Li₂HOCl_{0.75}Br_{0.25} and Li_{1.3}Al_{0.3}Ti_{1.7}(PO₄)₃ (LATP)

To prepare the composite electrolyte based on Li₂HOCl_{0.75}Br_{0.25} and LATP, a series of mixtures of Li₂HOCl_{0.75}Br_{0.25} and LATP with different volume ratios of 10/0, 8/2, 7/3, 6/4, 4/6 and 3/7 were mixed homogeneously. 200 mg of each mixture was cold-pressed into a Φ½ inch pellet under 250 MPa, and then hot-pressed at 200° C. under 35 kPa for 0.5 h. Once cooled, each pellet was dense and mechanically stable.

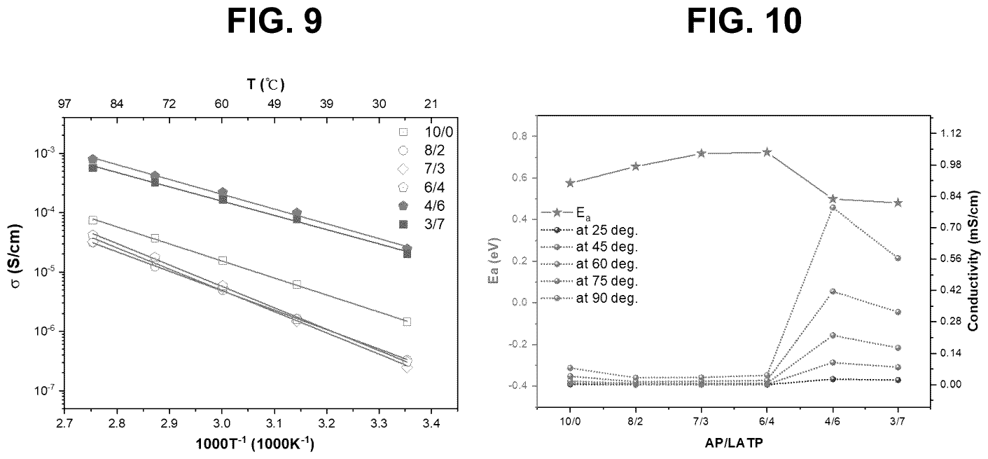

The ionic conductivity of the as-prepared composite electrolyte Li₂HOCl_{0.75}Br_{0.25}/LATP was evaluated by EIS tests at temperatures of 25° C., 45° C., 60° C., 75° C., and 90° C. FIG. 9 shows an Arrhenius conductivity plot based on the EIS results. FIG. 10 shows the activation energy and the conductivity for the composite electrolyte Li₂HOCl_{0.75}Br_{0.25}/LLZTO with different volume ratios. FIGS. 9 and 10 show that the composite electrolyte Li₂HOCl_{0.75}Br_{0.25}/LATP with the volume ratio of 4/6 had a relatively low activation energy and a high ionic conductivity of about 0.79 mS/cm at 90° C.

### Electrochemical Performance Analysis of Symmetrical Li Metal Cells Using Composite Inorganic Solid-State Electrolyte

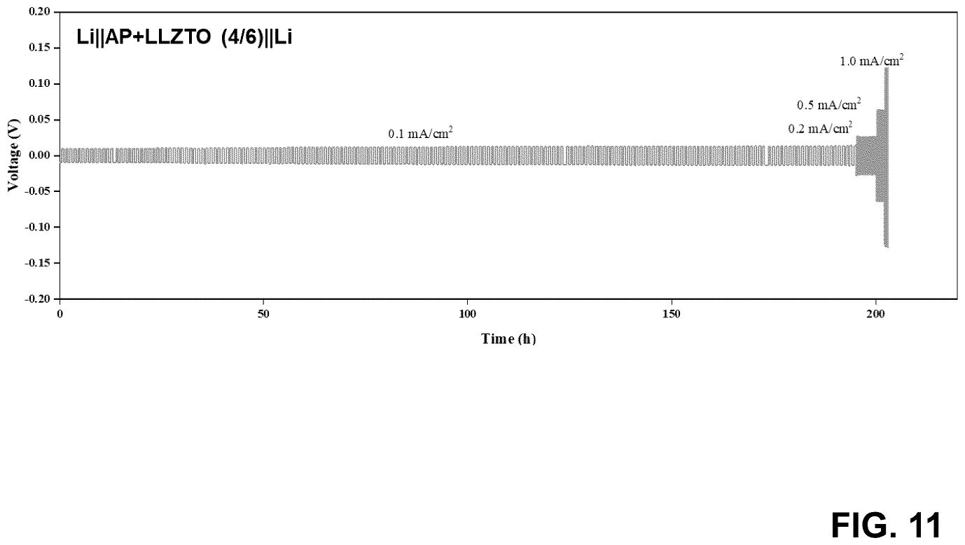

A symmetrical Li metal based cell was assembled using the composite electrolyte Li₂HOCl_{0.75}Br_{0.25}/LLZTO with the volume ratio of 4/6. FIG. 11 shows electrochemical cycling performance of the Li cell cycled at a temperature of about 60° C.

As shown in FIG. 11, the cell exhibited good stability at the current density of 0.1 mA/cm², and even when the current density increased to 1.0 mA/cm², the cell still exhibited smooth cycling, suggesting the composite electrolyte may withstand high current density cycling without Li dendrite penetration.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A solid electrolyte comprising:
a first inorganic solid electrolyte having a formula of Li_{3-y}H_{y}OX, where X is at least one halogen and 0<y≤1; and
a second inorganic solid electrolyte having an ionic conductivity greater than 0.01 mS/cm,
wherein the second inorganic solid electrolyte is dispersed in the first inorganic solid electrolyte forming a composite inorganic solid electrolyte.

2. The solid electrolyte of claim 1, wherein the first inorganic solid electrolyte and the second inorganic solid electrolyte are compounded together to form a composite inorganic solid electrolyte.

3. The solid electrolyte of claim 1, wherein the second inorganic solid electrolyte comprises at least one of a garnet-type solid electrolyte and a LiSICON solid electrolyte.

4. The solid electrolyte of claim 3, wherein the garnet-type solid electrolyte comprises at least one of lithium lanthanum zirconium oxide (Li₇La₃Zr₂O₁₂), lithium lanthanum zirconium tantalum oxide (Li₇₋ₓLa₃Zr₂₋ₓTaₓO₁₂, wherein 0<x<2), lithium lanthanum titanium oxide (LiₓLa_{(2-x)/3}TiO₃, 0<x<2), and lithium lanthanum bismuth oxide (Li₅La₃Bi₂O₁₂).

5. The solid electrolyte of claim 4, wherein the lithium lanthanum zirconium tantalum oxide has a formula of Li_{6.4}La₃Zr_{1.4}Ta_{0.6}O₁₂.

6. The solid state electrolyte of claim 3, wherein the LiSICON solid electrolyte is lithium aluminum titanium phosphate (Li₁₊ₓAlₓTi₂₋ₓ(PO₄)₃, 0<x<2).

7. The solid electrolyte of claim 6, wherein the lithium aluminum titanium phosphate has a formula of Li_{1.3}Al_{0.3}Ti_{1.7}(PO₄)₃.

8. The solid electrolyte of claim 1, wherein the first inorganic solid electrolyte has an anti-perovskite crystal structure and a melting temperature less than 500° C.

9. The solid electrolyte of claim 1, wherein X is F, Cl, Br, I, or a mixture of any two or more thereof.

10. The solid electrolyte of claim 9, wherein the first inorganic solid electrolyte comprises at least one of Li₂OHCl, Li₂OHCl_{0.25}Br_{0.75}, Li₂OHCl_{0.75}Br_{0.25}, Li₂OHBr, and Li₂OHCl_{0.5}Br_{0.5}.

11. The solid electrolyte of claim 1, wherein the first inorganic solid electrolyte and the second inorganic solid electrolyte are present in the solid electrolyte in a ratio of first inorganic solid electrolyte to second inorganic solid electrolyte of about 2:8 to about 8:2.

12. The solid electrolyte of claim 1, wherein the first inorganic solid electrolyte and the second inorganic solid electrolyte are present in the solid electrolyte in a ratio of first inorganic solid electrolyte to second inorganic solid electrolyte of about 3:7 to about 5:5.

13. A solid-state battery comprising:
a cathode;
an anode; and
a composite inorganic electrolyte disposed between and in physical contact with the cathode and the anode;
wherein:
the composite inorganic electrolyte comprises a dispersion of a second inorganic solid electrolyte in a first inorganic solid electrolyte, the first inorganic solid electrolyte having a formula of Li_{3-y}H_{y}OX where X is at least one halogen and 0<y≤1; and
at least a portion of the composite inorganic electrolyte is contained in at least one of the cathode or the anode.

14. The solid-state battery of claim 13, wherein the anode comprises at least one of metallic lithium, graphite, and Si.

15. The solid-state battery of claim 13, wherein the cathode comprises LiFe₁₋ₓMnₓPO₄, Li_{1+X}Mn₂₋ₓO₄, LiNiₓMn_{y}Co_{1-x-y}O₂, or a mixture of two or more thereof, wherein 0≤x≤1, 0≤y≤1, and 0≤x+y≤1.

16. The solid-state battery of claim 15, wherein the cathode further comprises a doping element selected from a group comprising of Mg, Ca, Zr, Ti, Ta, V, Cr, Fe, Zn, Al, and any combination of two or more thereof.
